(19) United States
(12) Patent Application Publication
(10) Pub. No.: US 2024/0002723 A1
(43) Pub. Date: Jan. 4, 2024

(54) An Indium-Oxygen Cluster, a Preparation Method therefor, a Quantum Dot Prepared Therefrom and a Preparation Method for said Quantum Dot

(71) Applicant: SUZHOU XINGSHUO NANOTECH CO., LTD., Suzhou, Jiangsu (CN)

(72) Inventors: Yuliang SHAN, Suzhou, Jiangsu (CN); Siyuan ZHANG, Suzhou, Jiangsu (CN)

(21) Appl. No.: 18/038,227

(22) PCT Filed: Nov. 24, 2021
(86) PCT No.: PCT/CN2021/132762

§ 371 Date: May 23, 2023

(30) Foreign Application Priority Data
Nov. 24, 2020 (CN) 202011325484.9

(51) Int. Cl. C09K 11/88; C01G 15/00; C09K 11/08

(52) U.S. Cl. CPC C09K 11/883; C01G 15/00; C09K 11/0883; B82Y 20/00

(57) ABSTRACT

The present disclosure provides an indium-oxygen cluster, a preparation method therefor, a quantum dot prepared therefrom and a preparation method for said quantum dot. The molecular formula of the indium-oxygen cluster is represented by R(Inₓ(O)_{y}, wherein R is selected from a substituted or unsubstituted aliphatic group, 0<x<1, and 0<y<1. Using quantum dots prepared from the indium-oxygen cluster of the present disclosure cannot only obtain a wider emission peak wavelength, but can also achieve a lower full width at half maxima, that is, the wavelength of obtained InP quantum dots is adjustable, and the quantum dots have small half-peaks, high efficiency and excellent performance.

The present application is a National Stage of International Patent Application No: PCT/CN2021/132762 filed on Nov. 24, 2021, which application claims the benefit of priority to the Chinese patent application No. 202011325484.9 filed on Nov. 24, 2020, which is herein incorporated by reference in their entirety.

### TECHNICAL FIELD

The present disclosure relates to the field of nanometer materials, and specifically, to an indium-oxygen cluster, a preparation method therefor, a quantum dot prepared therefrom and a preparation method for said quantum dot.

### BACKGROUND

With the advancement of quantum dot synthesis technologies and the deepening of quantum dot disclosures in related fields, there are more and more people concern about the toxicity of the quantum dots and the impact of the quantum dots on environments. Although the development of technologies of traditional group II-VI quantum dots such as CdTe and CdSe has been relatively mature, there is an inherent disadvantage of the cadmium (a toxic element) containing quantum dots, thus greatly limiting future disclosures of the quantum dots. For example, the Restriction of Hazardous Substances (RoHS) has considered the cadmium as one of the most dangerous toxic heavy metals, the European Union stipulates that, from October 2019, televisions and displays sold in Europe are restricted from using the harmful substance cadmium which is restricted in RoHS. In addition to the RoHS, many other international standards set restrictions to cadmium element too, for example, the IEEE 1680 standard limits the content of the cadmium in products below 100 ppm. Compared with the group II-VI quantum dots, group III-V quantum dots have relatively-low toxicity, especially InP quantum dots of which spectral range covers visible and near-infrared regions, these characteristics are not available in the traditional group II-VI quantum dots such as CdSe, and have gradually received the attention of many universities, research institutes and related enterprises in recent years.

Compared with the II-VI quantum dots of which synthetic process tends to be mature gradually, the way of obtaining high optical quality and high stability InP quantum dots to meet disclosure requirements in fields such as display and lighting is always the research difficulty and focus in the industry. Currently, common indium precursors for synthesizing the InP quantum dots are mainly indium halide or indium carboxylate, however, when the indium halide is used as the indium precursor, the obtained quantum dots are low in quantum yield and large in full width at half maxima; and when the indium carboxylate is used as the indium precursor, the obtained quantum dots are not easy to adjust wavelength, and large in full width at half maxima. Therefore, the optimization of a method for preparing InP quantum dots, especially the use of a novel indium precursor, has great importance of adjusting a wavelength range, increasing quantum yield and decreasing full width at half maxima.

### SUMMARY

The present disclosure is mainly intended to provide an indium-oxygen cluster, a preparation method therefor, a quantum dot prepared therefrom and a preparation method for said quantum dot, to solve the problem of poor performance of an InP quantum dot in the related art.

In order to implement the above objective, for the technical problem of poor performance of the InP quantum dot in the related art, an aspect of the present disclosure provides an indium-oxygen cluster, with a molecular formula being represented by R(InₓO_{)y}, wherein R is selected from a substituted or unsubstituted aliphatic group, 0<x<1, and 0<y<1.

Further, the weight percentage of indium in the indium-oxygen cluster is 15-25%.

Further, the R is selected from at least one of substituted or unsubstituted C6-C30 aliphatic hydrocarbon groups.

Further, the R is selected from at least one of substituted or unsubstituted C16-C18 aliphatic hydrocarbon groups.

In order to implement the above objective, an aspect of the present disclosure provides a method for preparing the indium-oxygen cluster, including a step of: performing heat treatment on indium fatty acid, so as to form the indium-oxygen cluster.

Further, the temperature of the heat treatment is not less than 300° C., and preferably, the temperature of the heat treatment is not greater than 350° C.

Preferably, the time for the heat treatment is not less than 0.5 h, and preferably, the time for the heat treatment is 0.5-3 h.

Preferably, the heat treatment is completed in an environment containing an inert gas.

Further, before heat treatment is performed, the indium fatty acid is dissolved in a solvent so as to form a solution; then heat treatment is performed on the solution; preferably, the solvent is a hydrocarbon compound of which boiling point exceeds 300° C.; more preferably, the solvent is C18-C30 alkane or olefin; and further preferably, the solvent is octadecene or octadecane.

Another aspect of the present disclosure further provides a method for preparing a quantum dot, a quantum dot includes a nuclear body, the nuclear body includes an indium-V compound, and a group-V element is P, the method for preparing a quantum dot includes the following steps:
S1, an indium-oxygen cluster is prepared according to the method;
S2, a group-V element precursor is added to the indium-oxygen cluster, so as to form the indium-V compound by means of reaction.

Further, in step S2, the indium-oxygen cluster is dispersed into a non-coordinated organic solvent, so as to form dispersion liquid; and the molar concentration of the indium-oxygen cluster is 0.01-1 mol/L.

Further, the non-coordinated organic solvent is one or more of hydrocarbon compounds of which boiling points are greater than 300° C.

Further, in the dispersion liquid, a mole ratio of the indium-oxygen cluster to the group-V element precursor is 1:(0.2-5), preferably 1:(0.5-2).

Further, the group-V element is phosphorus or arsenic, and the group-V element precursor includes at least one of P(SiR′₃)₃, PH(SiR′₃)₂, PH₂(SiR′₃), PH₃ or M(OCP)ₙ, wherein R′ is at least one of a substituted or unsubstituted aliphatic group or an aromatic group, M is a metal element, and n is a valence state value of the M element; and preferably, the M is selected from one or more of Li, Na, K, Zn, Ga, Al or In.

Further, a reaction temperature in the step S2 is 160-340° C., and preferably, the reaction temperature is 180-310° C.

Further, the preparation method further includes a process of forming a shell layer on the nuclear body, preferably, the shell layer is a shell layer of a group II-VI quantum dot; and preferably, the shell layer of the group II-VI quantum dot is any one or more of a ZnSe shell layer, a ZnS shell layer and a ZnSe/ZnS shell layer.

The present disclosure further provides a quantum dot, the quantum dot includes a nuclear body, and the nuclear body is prepared by means of the method for preparing a quantum dot.

Preferably, the nuclear body is InP; an emission peak of the quantum dot is located at 500-530 nm, and the full width at half maxima of the quantum dot is less than 34 nm; or the emission peak of the quantum dot is located at 531-570 nm, and the full width at half maxima of the quantum dot is less than 40 nm.

Through the disclosure of the technical solutions of the present disclosure, the method for preparing the indium-oxygen cluster of the present disclosure is simple, the molecular formula of the formed indium-oxygen cluster is represented by R(InₓO)_{y}, wherein the R is selected from a substituted or unsubstituted aliphatic group, 0<x<1, and 0<y<1, compared with indium fatty acid, the indium-oxygen cluster of the present disclosure shows a new characteristic peak in an XRD spectrum, so as to form a new structure, such that the indium-oxygen cluster has significantly-improved reaction activity and is more sensitive to temperatures, the wavelength of the prepared InP quantum dot may be controlled by adjusting the temperatures, the particle size distribution of the InP quantum dot does not deteriorate due to the increase in activity; on the contrary, the obtained InP quantum dot has a smaller full width at half maxima and higher quantum yield, therefore, the InP quantum dot obtains a smaller full width at half maxima and higher quantum yield.

### BRIEF DESCRIPTION OF THE DRAWINGS

The drawings, which form a part of this disclosure, are used to provide a further understanding of the present disclosure. The exemplary embodiments of the present disclosure and the description thereof are used to explain the present disclosure, but do not constitute improper limitations to the present disclosure. In the drawings:

FIG. 1 is a TGA diagram of an indium-oxygen cluster according to Embodiment 1 of the present disclosure;

FIG. 2 is a comparison diagram of absorption spectra of an indium-oxygen cluster and indium oleate according to Embodiment 1 of the present disclosure;

FIG. 3 is an XRD comparison diagram of an indium-oxygen cluster and indium oleate according to Embodiment 1 of the present disclosure;

FIG. 4 is an emission spectrum of quantum dots according to Embodiment 1 of the present disclosure.

### DETAILED DESCRIPTION OF THE EMBODIMENTS

It is to be noted that the embodiments in this disclosure and the features in the embodiments may be combined with one another without conflict. The disclosure will be described below in detail with reference to the drawings and the embodiments.

In addition, unless otherwise mentioned, a singular form is also intended to include a plural form, as used herein, “a”, “one (species/person)”, “the (said)” and “at least one (species/person) of . . . ” do not indicate quantitative limitations, but are intended to include both the singular form and the plural form, unless the context clearly indicates otherwise. For example, unless the context clearly indicates otherwise, “component (element)” has the same meaning as “at least one component (element)”. “At least one (species/person) of” is not to be interpreted as limiting “a” or “one (species/person) of”. The word “or” means “and/or”. As used herein, the term “and/or” includes any and all combinations of one or more of relevant listed items. It is to be further understood that, when the terms “include” and/or “comprise” or variations thereof are used in this specification, it indicates that there are stated features, regions, integral bodies, steps, operations, components and/or assemblies, but do not exclude the presence or addition of one or more other features, regions, integral bodies, steps, operations, components, assemblies and/or groups thereof.

As described in background, currently, in a common method for preparing an indium phosphide quantum dot, when a commonly indium precursor is used as indium carboxylate, the wavelength of the obtained quantum dot is not easy to adjust, and the quantum dot is large in full width at half maxima. The commonly indium precursor has insufficient activity, such that the performance of the prepared indium phosphide quantum dot is poor, based on this, the present disclosure first provides an indium-oxygen cluster, with a structure being R(InₓO)_{y}, wherein R is selected from a substituted or unsubstituted aliphatic group, 0<x<1, and 0<y<1. The inventor discovered that, when the indium-oxygen cluster of the present disclosure is used to prepare an InP quantum dot, since the indium-oxygen cluster has a specific cluster structure, the reaction activity is obviously improved, such that the indium-oxygen cluster may quickly react with a phosphorus precursor, so as to form a nucleus, under other equivalent reaction conditions, a quantum dot nucleation reaction rate is obviously higher than a quantum dot nucleation reaction rate when an indium carboxylate precursor is used, the formed InP quantum dot is small in wavelength while the particle size distribution of the InP quantum dot does not deteriorate with the increase in activity, such that the formed InP quantum dot has a small full width at half maxima, the selection of precursors and the setting of temperatures have large impact on the reaction, such that the accurate control of the wavelength may be achieved by adjusting two parameters. In addition, the inventor further discovered that the particle size distribution of InP prepared by an In source is desirable, and the full width at half maxima is small.

In a specific implementation of the present disclosure, the weight percentage of indium in the indium-oxygen cluster is 15-25%, compared with indium fatty acid, the content of the indium in the indium-oxygen cluster of the present disclosure is higher, and the weight percentage of the indium in the indium-oxygen cluster is increased by 20-50% compared with the corresponding indium carboxylate, such that the reaction activity when the indium-oxygen cluster is used as an indium source is obviously improved.

In another specific implementation of the present disclosure, the R in the structural formula is selected from at least one of C6-C30 aliphatic hydrocarbon groups, such that the indium-oxygen cluster with higher reaction activity may be obtained, so as to obtain the InP quantum dot with a small full width at half maxima and an adjustable wavelength range.

In some embodiments, the R is selected from at least one of substituted or unsubstituted C16-C18 aliphatic hydrocarbon groups.

The present disclosure further provides a method for preparing the indium-oxygen cluster, including a step of: performing heat treatment on indium fatty acid, so as to form the indium-oxygen cluster. By means of heat treatment, the structure of the indium fatty acid is changed, so as to form the indium-oxygen cluster with a plurality of oxygen atoms attached to indium atoms, that is, a cluster structure with indium and oxygen atoms arranged alternately is formed.

In a specific implementation of the present disclosure, the temperature of the heat treatment is not less than 300° C., such that there is enough energy to promote the reaction for forming the indium-oxygen cluster. Preferably, the temperature of the heat treatment is not less than 350° C. In another specific implementation of the present disclosure, the time for the heat treatment varies with the selection of precursors and the setting of temperatures, and a solution is kept warm for 10 min after the solution turns cloudy from clear, preferably, the time for the heat treatment is more than 0.5 hours, such that the indium fatty acid is fully reacted, so as to form the indium-oxygen cluster, the time for the heat treatment is preferably 0.5-3 hours, the reaction tends to be balanced, such that energy consumption is reduced.

In still another specific implementation of the present disclosure, the heat treatment is completed in an environment containing an inert gas, such that the indium fatty acid is not affected by external environments, and the indium-oxygen cluster formed by means of the reaction has higher purity.

Before the heat treatment is performed, the indium fatty acid is dissolved in a solvent so as to form a solution; then heat treatment is performed on the solution; preferably, the solvent is a hydrocarbon compound of which boiling point exceeds 300° C.; more preferably, the solvent is C18-C30 alkane or olefin; and further preferably, the solvent is octadecene or octadecane.

The present disclosure further provides a method for preparing a quantum dot, a quantum dot includes a nuclear body, the nuclear body includes an indium-V compound, and a group-V element is P. the method for preparing a quantum dot includes the following steps:
S1, heat treatment is performed on the indium fatty acid, so as to form the indium-oxygen cluster;

In the present disclosure, the indium fatty acid may be dissolved in a solvent to form a solution, and then heat treatment is performed on the solution, so as to form the indium-oxygen cluster, or heat treatment may be directly performed on the indium fatty acid, so as to form the indium-oxygen cluster, or heat treatment may be performed on a solution containing the indium fatty acid (for example, indium acetate) and corresponding fatty acid, so as to form the indium-oxygen cluster. Substances containing the indium fatty acid that are subjected to heat treatment so as to finally form the indium-oxygen cluster by means of reaction all fall within the protection scope of this disclosure.
S2, a group-V element precursor is added to the indium-oxygen cluster, so as to form an indium-V compound.

In the present disclosure, the reaction activity of the indium-oxygen cluster and the group-V element precursor is obviously improved, thereby facilitating the indium-oxygen cluster to react with the group-V element precursor, so as to rapidly form a nucleus. Under other equivalent reaction conditions, a nucleation rate is obviously higher than a nucleation rate of the indium fatty acid and the group-V element precursor, such that a quantum dot of which emission peak wavelength is easier to adjust may be obtained, but particle size distribution does not deteriorate with the increase in activity. In addition, the particle size distribution becomes better, and the quantum dot obtained in the present disclosure is narrower in full width at half maxima.

In a specific implementation of the present disclosure, in step S2, the indium-oxygen cluster is dispersed into a non-coordinated organic solvent, so as to form dispersion liquid, and the molar concentration of the indium-oxygen cluster is 0.01-1 mol/L, such that the indium-oxygen cluster fully reacts with the group-V element precursor later, the molar concentration of the indium-oxygen cluster is preferably 0.1-0.4 mol/L, in some embodiments, the non-coordinated organic solvent is one or more of hydrocarbon compounds of which boiling points are greater than 300° C.

In another specific implementation of the present disclosure, in the dispersion liquid, a mole ratio of the indium-oxygen cluster to the group-V element precursor is 1:(0.2-5), such that the quantum dot with a narrower full width at half maxima and higher quantum yield is obtained by means of preparation. The mole ratio of the indium-oxygen cluster to the group-V element precursor is preferably 1:(0.5-2).

In still another specific implementation of the present disclosure, the group-V element is phosphorus. For example the group-V element precursor includes at least one of P(SiR′₃)₃, PH(SiR′₃)₂, PH₂(SiR′₃), PH₃ or M(OCP)ₙ, wherein R′ is at least one of a substituted or unsubstituted aliphatic group or an aromatic group, M is a metal element, and n is a valence state value of the M element; and preferably, the M is selected from one or more of Li, Na, K, Zn, Ga, Al or In, and the n is 1, 2 or 3. Further, when the M element is a monovalent metal element such as Li, Na, K, Rb and Cs, the n is 1. When the M element is a divalent metal element such as Zn, Ca, Mn and Sr, the n is 2. And when the M element is a trivalent metal element such as Al, Ga and Tl, the n is 3.

In some embodiments, a phosphorus source M-(O—C≡P)ₙ is Li—O—C≡P, Na—O—C≡P, K—O—C≡P, Zn—(O—C≡P)₂, or Ga—(O—C≡P)₃. The indium-oxygen cluster reacts with a phosphorus precursor to nucleate at a faster rate; the emission peak wavelength range of the formed InP quantum dot is wider and easier to adjust, and the formed InP quantum dot is narrower in full width at half maxima.

For the reaction temperature in the step S2, refer to a commonly-used temperature for quantum dot preparation in the related art, in some embodiments, the reaction temperature in S2 is 160-340° C., and preferably, the reaction temperature is 180-310° C., so as to further achieve the advantages of the indium-oxygen cluster.

In some embodiments, the preparation method further includes a process of forming a shell layer on the nuclear body, preferably, the shell layer is a shell layer of a group II-VI quantum dot; and preferably, the shell layer of the group II-VI quantum dot is any one or more of a ZnSe shell layer, a ZnS shell layer and a ZnSe/ZnS shell layer. The process of forming the shell layer is a process of performing coating on the formed nuclear body, a specific preparation process may be referred to the related art, which is not described herein again. The present disclosure further provides a quantum dot, the quantum dot includes a nuclear body, and the nuclear body is prepared by means of the method for preparing a quantum dot, the emission peak of the quantum dot is adjustable in a wide range and easier to adjust, and the quantum dot is narrow in full width at half maxima.

In a preferred implementation, the nuclear body of the quantum dot of the present disclosure includes InP, the emission peak of the quantum dot is located at 500-530 nm, preferably 525-530 nm; and the full width at half maxima of the quantum dot is less than 34 nm, preferably 31-33 nm; or the emission peak of the quantum dot is located at 531-570 nm, and the full width at half maxima of the quantum dot is less than 40 nm, such that the use range of the quantum dot is widened, and the performance of the quantum dot is improved, the quantum dot of the present disclosure may be widely applied to preparation of a photoinduced quantum dot film and an electroluminescent layer, so as to obtain an excellent light-emitting effect, and may not only be applied to photoluminescence, but also be applied to electroluminescence.

This disclosure is further described in detail below with reference to specific embodiments, and the embodiments cannot be construed as limiting the scope of protection claimed in this disclosure.

### Embodiment 1

4 mmol of indium oleate was dissolved into 40 mL of octadecene (ODE); under an argon atmosphere, a temperature was heated to 310° C. and maintained for 1 h; when a solution turned light yellow and cloudy from colorless, clear and transparent, it indicated that an indium-oxygen cluster was formed; and the temperature was cooled to 260° C., a 0.2M P(TMS)₃ solution which was a tris(trimethylsilyl)phosphine solution was rapidly poured, where a solvent was TOP, that was, 15 mL of tri-octylphosphine, and then reaction was performed for 30 min. 20 mL of a 0.4M zinc stearate (Zn(St)₂) solution (a solvent being ODE) was added; 4 mL of a 2M tri-octylphosphine of elemental selenium (TOP-Se) solution was added; the temperature was heated to 310° C.; 20 mL of the 0.4M Zn(St)₂ solution (the solvent being ODE) was added; 4 mL of the 2M TOP-Se solution was added; and reaction was performed for one hour. The temperature was cooled to 240° C.; 40 mL of the 0.4M Zn(St)₂ solution (the solvent being ODE) was added; 8 mL of dodecanethiol (DDT) was added to perform reaction for two hours; and cooling was performed, and an InP/ZnSe/ZnS quantum dot was obtained after purification.

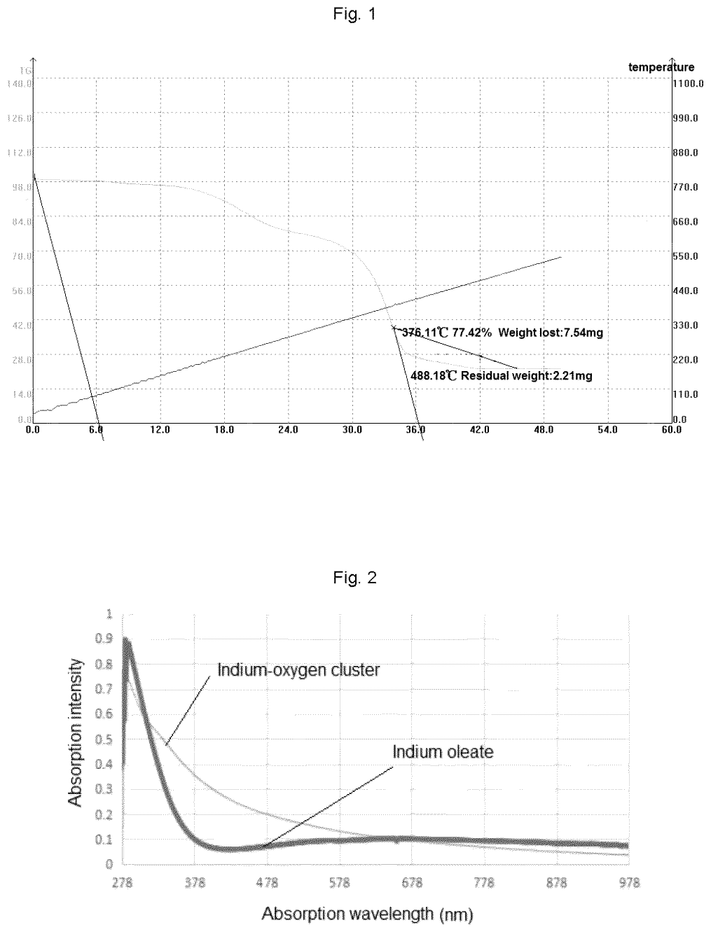

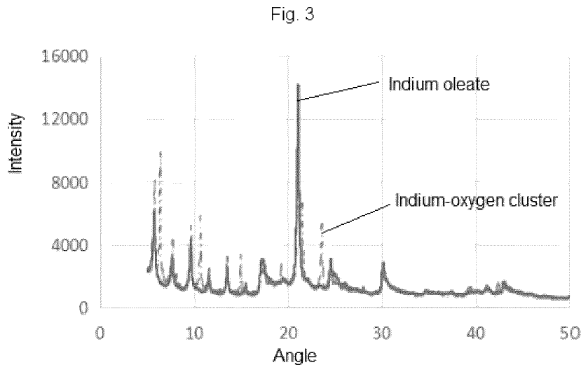

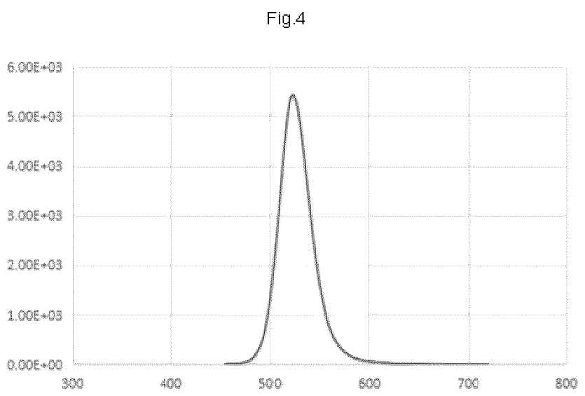

Thermogravimetric analysis (TGA) was performed on the indium oleate and the indium-oxygen cluster by using an RZY thermogravimetric analyzer, and results were shown in FIG. 1; the TGA of the indium-oxygen cluster was 23%, and a TGA theoretical value of the indium oleate was 15%; and the residual solid content of the indium-oxygen cluster was obviously greater than that of the corresponding indium fatty acid, it could be learned that, a new substance-indium-oxygen cluster was formed by performing heating treatment reaction on the indium oleate, it could be seen therefrom that the carboxylate ions forming anhydride and was removed, leaving more inorganic. A PerkinElmer Lambda 650 spectrophotometer was used to measure the ultraviolet absorbance of the indium oleate and the indium-oxygen cluster, and results were shown in FIG. 2; and it could be seen that, the UV absorption peak of the indium-oxygen cluster becomes wider, and the absorbance of the indium-oxygen cluster at a blue band was significantly greater than that of the indium fatty acid, furthermore, the absorption of UV-visible spectrum at a large wavelength was obviously weakened, which indicated the disappearance of the C═O double bond, and the change of the XRD characteristic peak also showed that this was a new compound; a SmartLab 3 KW powder diffractometer was used to perform XRD scanning on the indium oleate and the indium-oxygen cluster, and results were shown in FIG. 3; and it could be seen that, an X-ray diffraction pattern of the indium-oxygen cluster shown obvious characteristic absorption peaks within a range of a diffraction angle 20 with a value being 23°-24°, while the indium oleate had no characteristic absorption peaks within the corresponding range, and it could be learned that a crystal form of the indium oleate was different from that of the indium-oxygen cluster, a hatichi F4500 fluorescence photometer was used to measure an emission spectrum of the prepared InP/ZnSe/ZnS quantum dot, as shown in FIG. 4.

### Comparative Example 1

4 mmol of the indium oleate was dissolved into 40 mL of the ODE; under the argon atmosphere, the temperature was heated to 260° C.; 15 mL of the 0.2M P(TMS)₃ solution (the solvent being TOP) was rapidly poured; and then reaction was performed for 30 min. 20 mL of the 0.4M Zn(St)₂ solution (the solvent being ODE) was added; and 4 mL of the 2M TOP-Se solution was added. The temperature was heated to 310° C.; 20 mL of the 0.4M Zn(St)₂ solution (the solvent being ODE) was added; 4 mL of the 2M TOP-Se solution was added; reaction was performed for one hour; the temperature was cooled to 240° C.; 40 mL of the 0.4M Zn(St)₂ solution (the solvent being ODE) was added; 8 mL of DDT was added dropwise for 2 hours; and cooling was performed, and the InP/ZnSe/ZnS quantum dot was obtained after purification.

### Embodiment 2

4 mmol of indium palmitate was dissolved into 40 mL of the ODE; under the argon atmosphere, the temperature was heated to 310° C. and maintained for 1 h; when the solution turns light yellow and cloudy from colorless, clear and transparent, it indicated that the indium-oxygen cluster was formed; and the temperature was cooled to 260° C., 15 mL of the 0.2M P(TMS)₃ solution (the solvent being TOP) was rapidly poured; and then reaction was performed for 30 min. 20 mL of the 0.4M Zn(St)₂ solution (the solvent being ODE) was added; 4 mL of the 2M TOP-Se solution was added dropwise; and reaction was performed for one hour. The temperature was heated to 310° C.; 20 mL of the 0.4M Zn(St)₂ solution (the solvent being ODE) was added; 4 mL of the 2M TOP-Se solution was added dropwise; and reaction was performed for one hour, the temperature was cooled to 240° C.; 40 mL of the 0.4M Zn(St)₂ solution (the solvent being ODE) was added; 8 mL of the DDT was added to perform reaction for 2 hours; and cooling was performed, and the InP/ZnSe/ZnS quantum dot was obtained after purification.

### Comparative Example 2

4 mmol of the indium palmitate was dissolved into 40 mL of the ODE; under the argon atmosphere, the temperature was heated to 260° C.; 15 mL of the 0.2M P(TMS)₃ solution (the solvent being TOP) was rapidly poured; and then reaction was performed for 30 min. 20 mL of the 0.4M Zn(St)₂ solution (the solvent being ODE) was added; 4 mL of the 2M TOP-Se solution was added dropwise; and reaction was performed for one hour. The temperature was heated to 310° C.; 20 mL of the 0.4M Zn(St)₂ solution (the solvent being ODE) was added; and 4 mL of the 2M TOP-Se solution was added dropwise within 1 hour. The temperature was cooled to 240° C.; 40 mL of the 0.4M Zn(St)₂ solution (the solvent being ODE) was added; 8 mL of the DDT was added to perform reaction for 2 hours; and cooling was performed, and the InP/ZnSe/ZnS quantum dot was obtained after purification.

### Embodiment 3

4 mmol of indium oleate was added to a reaction flask; under the argon atmosphere, the temperature was heated to 310° C. and maintained for 1 h; when the solution turned light yellow and cloudy from colorless, clear and transparent, it indicated that the indium-oxygen cluster was formed; and the temperature was cooled to 260° C.; 40 mL of the ODE was added; 15 mL of the 0.2M P(TMS)₃ solution (the solvent being TOP) was rapidly poured; and then reaction was performed for 30 min. 20 mL of the 0.4M Zn(St)₂ solution (the solvent being ODE) was added; 4 mL of the 2M TOP-Se solution was added dropwise; and reaction was performed for 1 hour. The temperature was heated to 310° C.; 20 mL of the 0.4M Zn(St)₂ solution (the solvent being ODE) was added; 4 mL of the 2M TOP-Se solution was added dropwise; and reaction was performed for one hour. The temperature was cooled to 240° C.; 40 mL of the 0.4M Zn(St)₂ solution (the solvent being ODE) was added; 8 mL of the DDT was added to perform reaction for 2 hours; and cooling was performed, and the InP/ZnSe/ZnS quantum dot was obtained after purification.

### Embodiment 4

4 mmol of indium palmitate was added to a reaction flask; under the argon atmosphere, the temperature was heated to 310° C. and maintained for 1 h; when the solution turned light yellow and cloudy from colorless, clear and transparent, it indicated that the indium-oxygen cluster was formed; and the temperature was cooled to 260° C.; 40 mL of the ODE was added; 15 mL of the 0.2M P(TMS)₃ solution (the solvent being TOP) was rapidly poured; and then reaction was performed for 30 min. 20 mL of the 0.4M Zn(St)₂ solution (the solvent being ODE) was added; 4 mL of the 2M TOP-Se solution was added; and reaction was performed for 1 hour. The temperature was heated to 310° C.; 20 mL of the 0.4M Zn(St)₂ solution (the solvent being ODE) was added; 4 mL of the 2M TOP-Se solution was added dropwise; and reaction was performed for 1 hour. The temperature was cooled to 240° C.; 40 mL of the 0.4M Zn(St)₂ solution (the solvent being ODE) was added; 8 mL of the DDT was added to perform reaction for 2 hours; and cooling was performed, and the InP/ZnSe/ZnS quantum dot was obtained after purification.

### Embodiment 5

12 mmol of oleic acid was added to a reaction flask; 4 mmol of indium acetate and 40 mL of the ODE were added; under the argon atmosphere, the temperature was heated to 310° C. and maintained for 1 h; when the solution turned light yellow and cloudy from colorless, clear and transparent, it indicated that the indium-oxygen cluster was formed; and the temperature was cooled to 260° C.; 15 mL of the 0.2M P(TMS)₃ solution (the solvent being TOP) was rapidly poured; and then reaction was performed for 30 min. 20 mL of the 0.4M Zn(St)₂ solution (the solvent being ODE) was added; 4 mL of the 2M TOP-Se solution was added dropwise; and reaction was performed for 1 hour. The temperature was heated to 310° C.; 20 mL of the 0.4M Zn(St)₂ solution (the solvent being ODE) was added; 4 mL of the 2M TOP-Se solution was added; and reaction was performed for 1 hour. The temperature was cooled to 240° C.; 40 mL of the 0.4M Zn(St)₂ solution (the solvent being ODE) was added; 8 mL of the DDT was added to perform reaction for 2 hours; and cooling was performed, and the InP/ZnSe/ZnS quantum dot was obtained after purification.

### Embodiment 6

12 mmol of the oleic acid was added to a reaction flask; 4 mmol of indium acetate was added; under the argon atmosphere, the temperature was heated to 310° C. and maintained for 1 h; when the solution turned light yellow and cloudy from colorless, clear and transparent, it indicated that the indium-oxygen cluster was formed; and the temperature was cooled to 260° C.; 40 mL of the ODE was added; 15 mL of the 0.2M P(TMS)₃ solution (the solvent being TOP) was rapidly poured; and then reaction was performed for 30 min. 20 mL of the 0.4M Zn(St)₂ solution (the solvent being ODE) was added; 4 mL of the 2M TOP-Se solution was added; and reaction was performed for 1 hour. The temperature was heated to 310° C.; 20 mL of the 0.4M Zn(St)₂ solution (the solvent being ODE) was added; 4 mL of the 2M TOP-Se solution was added; and reaction was performed for 1 hour. The temperature was cooled to 240° C.; 40 mL of the 0.4M Zn(St)₂ solution (the solvent being ODE) was added; 8 mL of the DDT was added to perform reaction for 2 hours; and cooling was performed, and the InP/ZnSe/ZnS quantum dot was obtained after purification.

### Embodiment 7

4 mmol of the indium oleate was dissolved into 40 mL of the ODE; under the argon atmosphere, the temperature was heated to 310° C. and maintained for 1 h; when the solution turned light yellow and cloudy from colorless, clear and transparent, it indicated that the indium-oxygen cluster was formed; and the temperature was cooled to 270° C., 15 mL of the 0.2M P(TMS)₃ solution (the solvent being TOP) was rapidly poured; and then reaction was performed for 30 min. 20 mL of the 0.4M Zn(St)₂ solution (the solvent being ODE) was added; 4 mL of the 2M TOP-Se solution was added; and reaction was performed for 1 hour. The temperature was heated to 310° C.; 20 mL of the 0.4M Zn(St)₂ solution (the solvent being ODE) was added; 4 mL of the 2M TOP-Se solution was added; and reaction was performed for 1 hour. The temperature was cooled to 240° C.; 40 mL of the 0.4M Zn(St)₂ solution (the solvent being ODE) was added; 8 mL of the DDT was added to perform reaction for 2 hours; and cooling was performed, and the InP/ZnSe/ZnS quantum dot was obtained after purification.

### Embodiment 8

4 mmol of the indium oleate was dissolved into 40 mL of the ODE; under the argon atmosphere, the temperature was heated to 310° C. and maintained for 1 h; when the solution turned light yellow and cloudy from colorless, clear and transparent, it indicated that the indium-oxygen cluster was formed; and the temperature was cooled to 280° C., 15 mL of the 0.2M P(TMS)₃ solution (the solvent being TOP) was rapidly poured; and then reaction was performed for 30 min. 20 mL of the 0.4M Zn(St)₂ solution (the solvent being ODE) was added; 4 mL of the 2M TOP-Se solution was added; and reaction was performed for 1 hour. The temperature was heated to 310° C.; 20 mL of the 0.4M Zn(St)₂ solution (the solvent being ODE) was added; 4 mL of the 2M TOP-Se solution was added; and reaction was performed for 1 hour. The temperature was cooled to 240° C.; 40 mL of the 0.4M Zn(St)₂ solution (the solvent being ODE) was added; 8 mL of the DDT was added to perform reaction for 2 hours; and cooling was performed, and the InP/ZnSe/ZnS quantum dot was obtained after purification.

### Embodiment 9

4 mmol of the indium oleate was dissolved into 40 mL of the ODE; under the argon atmosphere, the temperature was heated to 310° C. and maintained for 1 h; when the solution turned light yellow and cloudy from colorless, clear and transparent, it indicated that the indium-oxygen cluster was formed; and the temperature was cooled to 260° C., 15 mL of the 0.2M PH₃ solution (the solvent being TOP) was rapidly poured; and then reaction was performed for 30 min. 20 mL of the 0.4M Zn(St)₂ solution (the solvent being ODE) was added; 4 mL of the 2M TOP-Se solution was added; the temperature was heated to 310° C.; 20 mL of the 0.4M Zn(St)₂ solution (the solvent being ODE) was added; 4 mL of the 2M TOP-Se solution was added; and reaction was performed for one hour. The temperature was cooled to 240° C.; 40 mL of the 0.4M Zn(St)₂ solution (the solvent being ODE) was added; 8 mL of the DDT was added to perform reaction for two hours; and cooling was performed, and the InP/ZnSe/ZnS quantum dot was obtained after purification.

### Embodiment 10

4 mmol of the indium oleate was dissolved into 40 mL of the ODE; under the argon atmosphere, the temperature was heated to 310° C. and maintained for 1 h; when the solution turned light yellow and cloudy from colorless, clear and transparent, it indicated that the indium-oxygen cluster was formed; and the temperature was cooled to 260° C.; 15 mL of the 0.2M Na(OCP) solution (the solvent being oleylamine) was rapidly poured; and then reaction was performed for 30 min. 20 mL of the 0.4M Zn(St)₂ solution (the solvent being ODE) was added; 4 mL of the 2M TOP-Se solution was added; the temperature was heated to 310° C.; 20 mL of the 0.4M Zn(St)₂ solution (the solvent being ODE) was added; 4 mL of the 2M TOP-Se solution was added; and reaction was performed for one hour. The temperature was cooled to 240° C.; 40 mL of the 0.4M Zn(St)₂ solution (the solvent being ODE) was added; 8 mL of the DDT was added to perform reaction for two hours; and cooling was performed, and the InP/ZnSe/ZnS quantum dot was obtained after purification.

### Embodiment 11

4 mmol of the indium oleate was dissolved into 40 mL of the ODE; under the argon atmosphere, the temperature was heated to 310° C. and maintained for 1 h; when the solution turned light yellow and cloudy from colorless, clear and transparent, it indicated that the indium-oxygen cluster was formed; and the temperature was cooled to 260° C.; 40 mL of the 0.2M P(TMS)₃ solution (the solvent being TOP) was rapidly poured; and then reaction was performed for 30 min. 20 mL of the 0.4M Zn(St)₂ solution (the solvent being ODE) was added; 4 mL of the 2M TOP-Se solution was added; the temperature was heated to 310° C.; 20 mL of the 0.4M Zn(St)₂ solution (the solvent being ODE) was added; 4 mL of the 2M TOP-Se solution was added; and reaction was performed for one hour. The temperature was cooled to 240° C.; 40 mL of the 0.4M Zn(St)₂ solution (the solvent being ODE) was added; 8 mL of the DDT was added to perform reaction for two hours; and cooling was performed, and the InP/ZnSe/ZnS quantum dot was obtained after purification.

### Embodiment 12

4 mmol of the indium oleate was dissolved into 40 mL of the ODE; under the argon atmosphere, the temperature was heated to 310° C. and maintained for 1 h; when the solution turned light yellow and cloudy from colorless, clear and transparent, it indicated that the indium-oxygen cluster was formed; and the temperature was cooled to 260° C.; 10 mL of the 0.2M P(TMS)₃ solution (the solvent being TOP) was rapidly poured; and then reaction was performed for 30 min. 20 mL of the 0.4M Zn(St)₂ solution (the solvent being ODE) was added; 4 mL of the 2M TOP-Se solution was added; the temperature was heated to 310° C.; 20 mL of the 0.4M Zn(St)₂ solution (the solvent being ODE) was added; 4 mL of the 2M TOP-Se solution was added; and reaction was performed for one hour. The temperature was cooled to 240° C.; 40 mL of the 0.4M Zn(St)₂ solution (the solvent being ODE) was added; 8 mL of the DDT was added to perform reaction for two hours; and cooling was performed, and the InP/ZnSe/ZnS quantum dot was obtained after purification.

### Embodiment 13

4 mmol of the indium oleate was dissolved into 40 mL of the ODE; under the argon atmosphere, the temperature was heated to 310° C. and maintained for 1 h; when the solution turned light yellow and cloudy from colorless, clear and transparent, it indicated that the indium-oxygen cluster was formed; and the temperature was cooled to 260° C.; 100 mL of the 0.2M P(TMS)₃ solution (the solvent being TOP) was rapidly poured; and then reaction was performed for 30 min. 20 mL of the 0.4M Zn(St)₂ solution (the solvent being ODE) was added; 4 mL of the 2M TOP-Se solution was added; the temperature was heated to 310° C.; 20 mL of the 0.4M Zn(St)₂ solution (the solvent being ODE) was added; 4 mL of the 2M TOP-Se solution was added; and reaction was performed for one hour. The temperature was cooled to 240° C.; 40 mL of the 0.4M Zn(St)₂ solution (the solvent being ODE) was added; 8 mL of the DDT was added to perform reaction for two hours; and cooling was performed, and the InP/ZnSe/ZnS quantum dot was obtained after purification.

### Embodiment 14

4 mmol of the indium oleate was dissolved into 40 mL of the ODE; under the argon atmosphere, the temperature was heated to 310° C. and maintained for 1 h; when the solution turned light yellow and cloudy from colorless, clear and transparent, it indicated that the indium-oxygen cluster was formed; and the temperature was cooled to 260° C.; 4 mL of the 0.2M P(TMS)₃ solution (the solvent being TOP) was rapidly poured; and then reaction was performed for 30 min. 20 mL of the 0.4M Zn(St)₂ solution (the solvent being ODE) was added; 4 mL of the 2M TOP-Se solution was added; the temperature was heated to 310° C.; 20 mL of the 0.4M Zn(St)₂ solution (the solvent being ODE) was added; 4 mL of the 2M TOP-Se solution was added; and reaction was performed for one hour. The temperature was cooled to 240° C.; 40 mL of the 0.4M Zn(St)₂ solution (the solvent being ODE) was added; 8 mL of the DDT was added to perform reaction for two hours; and cooling was performed, and the InP/ZnSe/ZnS quantum dot was obtained after purification.

### Embodiment 15

The difference between this embodiment and Embodiment 1 lied in that, the indium oleate was replaced with indium caproate.

### Embodiment 16

The difference between this embodiment and Embodiment 1 lied in that, the indium oleate was replaced with indium triacontanoate.

### Embodiment 17

The difference between this embodiment and Embodiment 1 lied in that, the temperature was heated to 310° C. and maintained for 0.5 h; and when the solution turned light yellow and cloudy from colorless, clear and transparent, it indicated that the indium-oxygen cluster was formed.

### Embodiment 18

The difference between this embodiment and Embodiment 1 lied in that, the temperature was heated to 310° C. and maintained for 3 h; and when the solution turned light yellow and cloudy from colorless, clear and transparent, it indicated that the indium-oxygen cluster was formed.

The hatichi F4500 fluorescence photometer was used (by combining an agilent8453 ultraviolet visible spectrophotometer) to measure the emission peak wavelength, full width at half maxima and quantum yield of the InP/ZnSe/ZnS quantum dot in Embodiments 1-18 and Comparative examples 1-2, and results were shown in Table 1. It could be seen that, compared with Comparative examples 1-2, the emission peak wavelength of the InP/ZnSe/ZnS quantum dot in Embodiments 1-18 was easy to adjust, and the quantum dot was narrow in full width at half maxima and high in quantum yield. The weight percentage of the indium in the indium-oxygen cluster was tested by means of a TGA method.

TABLE 1

| | | | | Weight |
|---|---|---|---|---|
| | | Full width | | percentage |
| | | at half | | of indium in |
| | Wavelength | maxima | Quantum | indium-oxygen |
| No. | (nm) | (nm) | yield | cluster |
| Embodiment 1 | 527 | 31 | 78% | 23% |
| Comparative | 535 | 38 | 72% | 15% |
| example 1 | | | | |
| Embodiment 2 | 525 | 32 | 80% | 25% |
| Comparative | 535 | 39 | 72% | 16% |
| example 2 | | | | |
| Embodiment 3 | 528 | 32 | 77% | 23% |
| Embodiment 4 | 528 | 32 | 75% | 25% |
| Embodiment 5 | 527 | 33 | 73% | 23% |
| Embodiment 6 | 527 | 33 | 73% | 23% |
| Embodiment 7 | 532 | 32 | 72% | 23% |
| Embodiment 8 | 537 | 32 | 75% | 23% |
| Embodiment 9 | 512 | 31 | 80% | 23% |
| Embodiment 10 | 568 | 38 | 85% | 23% |
| Embodiment 11 | 523 | 33 | 75% | 23% |
| Embodiment 12 | 535 | 33 | 74% | 23% |
| Embodiment 13 | 518 | 33 | 75% | 23% |
| Embodiment 14 | 546 | 34 | 72% | 23% |
| Embodiment 15 | 524 | 32 | 76% | 38% |
| Embodiment 16 | 528 | 32 | 75% | 15% |
| Embodiment 17 | 527 | 32 | 77% | 23% |
| Embodiment 18 | 528 | 32 | 76% | 23% |

In the present application, fatty acid indium has a high purity, and a high-purity C6-C30 fatty acid indium gradually forms a reticular cluster structure at a high temperature, thus, a novel indium source with high purity and moderate activity is obtained. The physicochemical properties of this indium source are completely different from those of the C6-C30 fatty acid indiums which we have used in practice, for example, a TGA (thermogravimetric) of the resultant cluster prepared from indium oleate was 23%, while a TGA theoretical value of the indium oleate was 15%, this indicated that the carboxylate ions forming anhydride and was removed, leaving more inorganic.

It could be seen from the data in Example 1 to Example 18 of the present application that, since the new indium oxide cluster compound of the present application had a higher purity and was completely free of acetic acid, it was applied to nucleation of InP, and the wavelength of the prepared product was more controllable. The advantages brought about by the high purity were that the emission wavelength of the indium phosphide quantum dot could be easily regulated and controlled only by regulating and controlling the ratio of the indium source to the phosphorus source and the temperature of the reaction, the ratio of the acetate ions and the fatty acid root ions in the indium source did not need to be taken into consideration. The obtained indium phosphide quantum dot had a narrower half peak width; and along with the improvement of the purity of the indium source, the particle size distribution of the product was more uniform, which was obvious. Hence, in the range of green light, we made the full width at half maxima of 31 nm through breakthrough, which was a big improvement in performance of indium phosphide quantum dots, and thus gave a firm foundation for the future application of indium phosphide quantum dots in the display field of high color gamut.

The above are only the preferred embodiments of the present disclosure and are not intended to limit the present disclosure. For those skilled in the art, the present disclosure may have various modifications and variations. Any modifications, equivalent replacements, improvements and the like made within the spirit and principle of the present disclosure shall fall within the scope of protection of the present disclosure.

1. An indium-oxygen cluster, with a molecular formula being represented by R(InₓO)_{y}, wherein R is selected from a substituted or unsubstituted aliphatic group, 0<x<1, and 0<y<1.

2. The indium-oxygen cluster according to claim 1, wherein the weight percentage of indium in the indium-oxygen cluster is 15-25%.

3. The indium-oxygen cluster according to claim 1,
wherein the R is selected from at least one of substituted or unsubstituted C6-C30 aliphatic hydrocarbon groups;
preferably, the R is selected from at least one of substituted or unsubstituted C16-C18 aliphatic hydrocarbon groups.

4. A method for preparing the indium-oxygen cluster according to claim 1, comprising a step of: performing heat treatment on indium fatty acid, so as to form the indium-oxygen cluster.

5. The method for preparing the indium-oxygen cluster according to claim 4, wherein the temperature of the heat treatment is not less than 300° C., and preferably, the temperature of the heat treatment is not greater than 350° C.; preferably, the time for the heat treatment is not less than 0.5 h, and preferably, the time for the heat treatment is 0.5-3 h;
preferably, the heat treatment is performed in an environment containing an inert gas.

6. The method for preparing the indium-oxygen cluster according to claim 5, wherein before the heat treatment is performed, the indium fatty acid is dissolved in a solvent so as to form a solution; then heat treatment is performed on the solution; preferably, the solvent is a hydrocarbon compound of which boiling point exceeds 300° C.; more preferably, the solvent is C18-C30 alkane or olefin; and further preferably, the solvent is octadecene or octadecane.

7. A method for preparing a quantum dot, wherein a quantum dot comprises a nuclear body, the nuclear body comprises an indium-V compound, and a group-V element is P; and the method for preparing a quantum dot comprises steps of:
S1, preparing an indium-oxygen cluster according to the preparation method according to claim 4; and
S2, adding a group-V element precursor to the indium-oxygen cluster, so as to form the indium-V compound by means of reaction.

8. The method for preparing a quantum dot according to claim 7, wherein in step S2, the indium-oxygen cluster is dispersed into a non-coordinated organic solvent, so as to form dispersion liquid; and the molar concentration of the indium-oxygen cluster is 0.01-1 mol/L;
preferably, a reaction temperature in the step S2 is 160-340° C., and preferably, the reaction temperature is 180-310° C.;
preferably, the non-coordinated organic solvent is one or more of hydrocarbon compounds of which boiling points are greater than 300° C., more preferably, the solvent is C18-C30 alkane or olefin, and further preferably, the solvent is octadecene or octadecane;
preferably, in the dispersion liquid, a mole ratio of the indium-oxygen cluster to the group-V element precursor is 1:(0.2-5), preferably 1:(0.5-2);
preferably, the group-V element is phosphorus, and the group-V element precursor comprises at least one of P(SiR′₃)₃, PH(SiR′₃)₂, PH₂(SiR′₃), PH₃ or M(OCP)ₙ, wherein R′ is at least one of a substituted or unsubstituted aliphatic group or an aromatic group, M is a metal element, and n is a valence state value of the M element; and
preferably, the M is selected from one or more of Li, Na, K, Zn, Ga, Al or In.

9. The method for preparing a quantum dot according to claim 8, further comprising a process of forming a shell layer on the nuclear body, wherein preferably, the shell layer is a shell layer of a group II-VI quantum dot; and preferably, the shell layer of the group II-VI quantum dot is any one or more of a ZnSe shell layer, a ZnS shell layer and a ZnSe/ZnS shell layer.

10. A quantum dot, comprising a nuclear body, wherein the nuclear body is prepared by means of the method according to claim 7;
preferably, the nuclear body is InP; an emission peak of the quantum dot is located at 500-530 nm, and the full width at half maxima of the quantum dot is less than 34 nm; or the emission peak of the quantum dot is located at 531-570 nm, and the full width at half maxima of the quantum dot is less than 40 nm.

11. The indium-oxygen cluster according to claim 2, wherein R is selected from at least one of substituted or unsubstituted C6-C30 aliphatic hydrocarbon groups;
preferably, R is selected from at least one of substituted or unsubstituted C16-C18 aliphatic hydrocarbon groups.

12. A method for preparing the indium-oxygen cluster according to claim 2, comprising a step of: performing heat treatment on indium fatty acid, so as to form the indium-oxygen cluster.

13. A method for preparing the indium-oxygen cluster according to claim 3, comprising a step of: performing heat treatment on indium fatty acid, so as to form the indium-oxygen cluster.

14. A method for preparing a quantum dot, wherein a quantum dot comprises a nuclear body, the nuclear body comprises an indium-V compound, and a group-V element is P; and the method for preparing a quantum dot comprises steps of:
S1, preparing an indium-oxygen cluster according to the preparation method according to claim 5; and
S2, adding a group-V element precursor to the indium-oxygen cluster, so as to form the indium-V compound by means of reaction.

15. A method for preparing a quantum dot, wherein a quantum dot comprises a nuclear body, the nuclear body comprises an indium-V compound, and a group-V element is P; and the method for preparing a quantum dot comprises steps of:
S1, preparing an indium-oxygen cluster according to the preparation method according to claim 6; and
S2, adding a group-V element precursor to the indium-oxygen cluster, so as to form the indium-V compound by means of reaction.

16. A quantum dot, comprising a nuclear body, wherein the nuclear body is prepared by means of the method according to claim 8;
preferably, the nuclear body is InP; an emission peak of the quantum dot is located at 500-530 nm, and the full width at half maxima of the quantum dot is less than 34 nm; or the emission peak of the quantum dot is located at 531-570 mu, and the full width at half maxima of the quantum dot is less than 40 nm.

17. A quantum dot, comprising a nuclear body, wherein the nuclear body is prepared by means of the method according to claim 9;
preferably, the nuclear body is InP; an emission peak of the quantum dot is located at 500-530 nm, and the full width at half maxima of the quantum dot is less than 34 mu; or the emission peak of the quantum dot is located at 531-570 nm, and the full width at half maxima of the quantum dot is less than 40 nm.
